(19) United States
(12) Patent Application Publication
(10) Pub. No.: US 2020/0182901 A1
(43) Pub. Date: Jun. 11, 2020

(54) WIRELESS COMMUNICATION POINT INSPECTION VIBROMETER CONFIGURED TO MONITOR VIBRATION AND TEMPERATURE OF ROTATING EQUIPMENT

(71) Applicant: FATRI United Testing & Control (Quanzhou) Technologies Co., Ltd., Quanzhou City (CN)

(72) Inventors: Yongzhong Nie, Quanzhou City (CN); Chengxu Luo, Quanzhou City (CN)

(21) Appl. No.: 16/704,423

(22) Filed: Dec. 5, 2019

(30) Foreign Application Priority Data
Dec. 5, 2018 (CN) 2018220369258

(51) Int. Cl. G01P 15/09; G08C 17/02

(52) U.S. Cl. CPC G01P 15/0907; G08C 17/02

(57) ABSTRACT

The present disclosure relates to the technical field of wireless detection, in particular to a wireless communication point inspection vibrometer configured to monitor vibration and temperature of rotating equipment, comprising: a housing, internally provided with a piezoelectric transducer, a temperature detection component and a first printed circuit board, wherein the piezoelectric transducer and the temperature detection component are both in communication connection with the first printed circuit board, and the first printed circuit board is provided with a wireless transmitting component. The present disclosure solves the problems that an external antenna is adopted in signal transmission of a piezoelectric acceleration transducer in the prior art, and the external antenna is large in volume and is not convenient to be installed in a relatively small space.

### CROSS REFERENCE TO RELATED APPLICATIONS

This application claims priority to Chinese Patent Application No. 2018220369258, filed on Dec. 5, 2018, the entire contents of which are incorporated herein by reference.

### TECHNICAL FIELD

The present disclosure relates to the technical field of wireless detection, in particular to a wireless communication point inspection vibrometer configured to monitor vibration and temperature of rotating equipment.

### BACKGROUND ART

A variety of rotating equipment is available, including various generators, driving motors, different forms of gear boxes, pumps and fans. Rotating equipment plays a critical role in promoting a process of national industrialization and electrification. In critical areas which are vital to national interest and human's livelihood and national security, such as large-scale energy development, civil infrastructure, public rail transit and military industry, operating reliability of rotating equipment has strict requirements, and health degree of equipment has a great influence on production security.

In fault diagnosis of rotating equipment, much information is available for detection and diagnosis, wherein vibration signals can rapidly and directly reflect operating states of a bearing, a gear and a blade and other parts in the equipment. According to statistics, over 70% fault is reflected in a form of vibration; in addition, along with long-time operation of the equipment under a high load, environment temperature inside the equipment is also constantly changing, and too-high or too-low operating temperature will adversely affect the equipment, therefore, acquisition of temperature information of equipment is of great significance to diagnosis of equipment fault.

To this end, a Chinese patent document CN203133107U discloses a piezoelectric acceleration transducer integrated with temperature detection, which can timely reflect actual operating temperature of an acceleration transducer, however, an external antenna is adopted for signal transmission, and the external antenna is large in volume and inconvenient to be installed in a relatively small space.

### SUMMARY

Therefore, a technical problem to be solved in the present disclosure is to overcome shortcomings that an external antenna is adopted in signal transmission of a piezoelectric acceleration transducer in the prior art, and the external antenna is large in volume and is not convenient to be installed in a relatively small space, and the present disclosure provides a wireless communication point inspection vibrometer configured to monitor vibration and temperature of rotating equipment which adopts no external antenna in signal transmission and which is relatively small in volume and can be installed in a relatively small space.

In order to solve the above technical problem, the present disclosure provides a wireless communication point inspection vibrometer configured to monitor vibration and temperature of rotating equipment, including a housing, internally provided with a piezoelectric transducer, a temperature detection component and a first printed circuit board, wherein the piezoelectric transducer and the temperature detection component are both in communication connection with the first printed circuit board, and the first printed circuit board is provided with a wireless transmitting component.

Further, the wireless transmitting component is a wireless patch.

Further, the housing is internally filled with pouring sealant.

Further, the housing is provided with a base, the piezoelectric transducer is arranged at the center of the base, and the temperature detection component is installed in a blind hole formed at a side part of the base.

Further, the base is further internally provided with a mounting hole configured to be connected with the rotating equipment.

Further, the housing is internally provided with a first bracket configured to install the first printed circuit board, and the first bracket is arranged above the piezoelectric transducer.

Further, the first bracket is installed with a battery configured to provide power.

Further, a light guide post arranged perpendicular to the first printed circuit board is further included, the other end of the light guide post extends to the outside of the housing, so as to transmit light source information displayed on the first printed circuit board to the outside of the housing.

Further, the piezoelectric transducer is installed on the base through a second bracket, and includes a piezoelectric ceramic and a mass block which are sleeved on the second bracket in sequence from inside to outside, and a second printed circuit board arranged above the mass block, and a shielding case is further arranged outside the second bracket.

Further, the piezoelectric ceramic is an annular structure formed through splicing of multiple single bodies.

The technical solution of the present disclosure has the following advantages:

1. As to the wireless communication point inspection vibrometer configured to monitor vibration and temperature of rotating equipment provided in the present disclosure, a piezoelectric transducer, a temperature detection component and a first printed circuit board are arranged in a housing, therefore, not only vibration frequency of rotating equipment can be detected, but also temperature of rotating equipment can be detected, vibration frequency signals and temperature signals are both transmitted to the first printed circuit board for collection, and then signals are transmitted to the outside of a housing through a wireless transmitting component arranged on the first printed circuit board, then no antenna needs to be installed outside a wireless communication point inspection vibrometer, thereby facilitating transportation and installation of a wireless communication point inspection vibrometer, meanwhile, an internal structure of a wireless communication point inspection vibrometer is also compact, thereby greatly reducing volume of a wireless communication point inspection vibrometer, and lowering requirements on an installation space.

2. As to the wireless communication point inspection vibrometer configured to monitor vibration and temperature of rotating equipment provided in the present disclosure, pouring sealant plays a role of isolating other structures of a housing from a piezoelectric transducer, and simultaneously lowers vibration noise of a piezoelectric transducer.

3. As to the wireless communication point inspection vibrometer configured to monitor vibration and temperature of rotating equipment provided in the present disclosure, a mounting hole arranged inside a base facilitates direct connection between a wireless communication point inspection vibrometer and rotating equipment, and no other tools are needed for connection, therefore, the connection is more reliable and convenient.

4. As to the wireless communication point inspection vibrometer configured to monitor vibration and temperature of rotating equipment provided in the present disclosure, an operating state of a wireless communication point inspection vibrometer can be observed from color changes of a light guide post which is arranged in a housing and extends to the outside of the housing, thereby being more beneficial for observation.

### BRIEF DESCRIPTION OF DRAWINGS

To describe the technical solution in the specific embodiments of the present disclosure or in the prior art more clearly, a brief introduction will be made below on the accompanying drawings required to be used in the specific embodiments or the prior art. Apparently, the accompanying drawings described below are some embodiments of the present disclosure. For those skilled in the art, other accompanying drawings can be obtained based on these accompanying drawings without any creative effort.

FIG. 1 is a structural schematic diagram of a wireless communication point inspection vibrometer configured to monitor vibration and temperature of rotating equipment provided in the present disclosure;

FIG. 2 is a perspective view of FIG. 1;

FIG. 3 is an enlarged view of a charging port;

FIG. 4 is a structural schematic diagram of a piezoelectric transducer in FIG. 1.

### REFERENCE NUMERALS IN THE FIGURES

1-first bracket; 2-charging port; 3-memory card slot; 4-piezoelectric transducer; 5-light guide post; 6-battery; 7-first printed circuit board; 8-temperature detection component; 9-mounting hole; 10-upper cover; 11-button; 12-housing; 13-base; 14-lock wire hole; 15-shielding case; 16-second printed circuit board; 17-mass block; 18-piezoelectric ceramic; 19-second bracket; 20-insulating spacer;

### DETAILED DESCRIPTION OF THE EMBODIMENTS

A clear and complete description of the technical solution of the present disclosure will be given below in combination with the accompanying drawings. Obviously, the described embodiments are only a part, but not all, of the embodiments of the present disclosure. Based on the embodiments of the present disclosure, all the other embodiments obtained by those of ordinary skill in the art without any creative effort shall all fall into the protection scope of the present disclosure.

In addition, the technical features involved in different embodiments of the present disclosure described below can be combined with each other as long as they are not conflicted with one another.

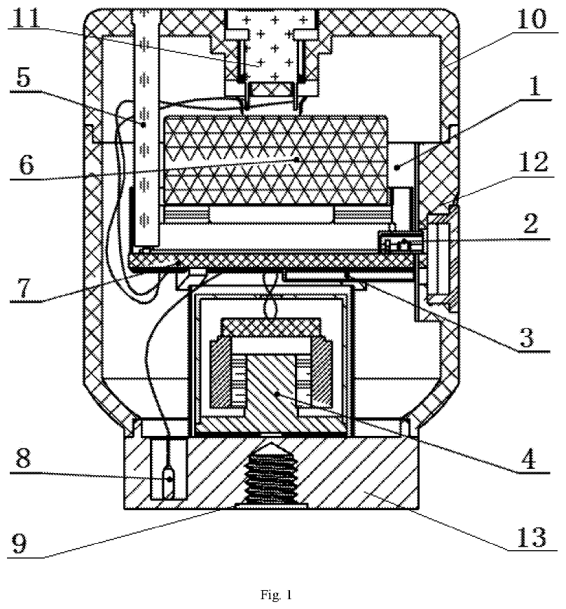

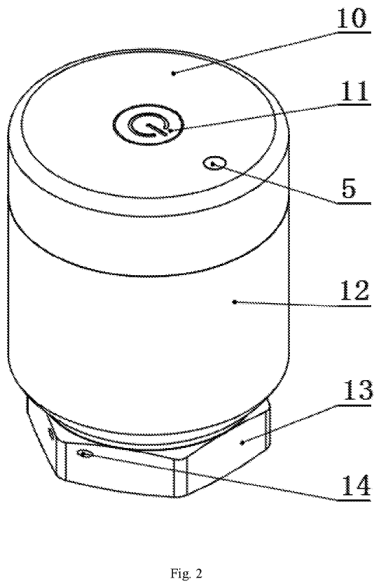

A specific embodiment of a wireless communication point inspection vibrometer configured to monitor vibration and temperature of rotating equipment as shown in FIGS. 1-4 includes a housing 12, internally provided with a piezoelectric transducer 4, a temperature detection component 8 and a first printed circuit board 7, wherein the piezoelectric transducer 4 and the temperature detection component 8 are both in communication connection with the first printed circuit board 7, and the first printed circuit board 7 is provided with a wireless transmitting component.

As to the above wireless communication point inspection vibrometer configured to monitor vibration and temperature of rotating equipment, a piezoelectric transducer 4, a temperature detection component 8 and a first printed circuit board 7 are arranged in a housing 12, the piezoelectric transducer 4, the temperature detection component 8 and the first printed circuit board 7 are connected mutually through a connecting line, the piezoelectric transducer 4 and the temperature detection component 8 acquire vibration signals and temperature signals of rotating equipment, and store acquired signals on the first printed circuit board 7, the first printed circuit board 7 is provided with a wireless transmitting component, and transmission of signals is completed through the wireless transmitting component, meanwhile, the first printed circuit board 7 is further integrated with a signal conditioning module configured to perform preliminary processing and storage on acquired information, and finally the acquired information is transmitted to a mobile terminal for analysis and post-processing, so as to reflect in real time a state of monitored equipment, provide reliable maintenance information for point inspection personnel, and further monitor vibration signals and temperature signals of rotating equipment. The wireless communication point inspection vibrometer can not only detect vibration signals of rotating equipment, but also detect temperature of rotating equipment, and no antenna needs to be installed outside a wireless communication point inspection vibrometer, thereby facilitating transportation and installation of a wireless communication point inspection vibrometer, meanwhile, an internal structure of a wireless communication point inspection vibrometer is also compact, thereby greatly reducing volume of a wireless communication point inspection vibrometer, and lowering requirements on an installation space.

A temperature detection component 8 is a thermistor, for example, a platinum resistance element, a resistance value of the platinum resistance element increases along with rise of temperature, the resistance value of the platinum resistance element is 100 ohm at 0° C., and is 138.5 ohm at 100° C., and acquisition of temperature signals can be realized through measuring resistance value of a platinum resistor.

The wireless transmitting component is a wireless patch. The wireless patch is integrated on a first printed circuit board 7, such that installation is more convenient and the structure is more compact.

The housing 12 is internally filled with pouring sealant, and the pouring sealant is filled in an unoccupied space inside the housing 12. The pouring sealant plays a role of isolating other structures inside the housing 12 from a piezoelectric transducer 4, and simultaneously lowers vibration noise of a piezoelectric transducer 4, reduces vibration strength of a piezoelectric transducer 4, and also prolongs service life of a piezoelectric transducer 4 and a wireless communication point inspection vibrometer.

The housing 12 is provided with a base 13, the piezoelectric transducer 4 is arranged at the center of the base 13, and the temperature detection component 8 is installed in a blind hole formed at a side part of the base 13. The base 13 is further internally provided with a mounting hole 9 configured to be connected with the rotating equipment. A piezoelectric transducer 4 is arranged in the middle of the base 13, an insulating spacer 20 is arranged between the base 13 and the piezoelectric transducer 4, and the insulating spacer 20 is an alumina ceramic insulating spacer, which plays a role of insulating, avoids electric leakage of the piezoelectric transducer 4, prevents a wireless communication point inspection vibrometer from connecting to electricity, and influences monitoring results of a wireless communication point inspection vibrometer which may deviate from actual results; the temperature detection component 8 is installed in a blind hole formed at a side part of the base 13, the blind hole is filled with high temperature-resistant heating-conducting glue, to complete encapsulation of the temperature detection component 8. The blind hole is arranged close to rotating equipment, with an aim of reducing distance between the temperature detection component 8 and the rotating equipment, such that the effect of monitoring temperature of rotating equipment by the temperature detection component 8 is better; a mounting hole 9 is arranged on an outer surface of a base 13, and the mounting hole 9 is a threaded hole, thereby reducing number of holes formed on a wireless communication point inspection vibrometer, and ensuring contact rigidity of a mounting surface. A double-thread bolted connection is adopted, one end is connected with the mounting hole 9 in the base 13, while the other end is connecting with the rotating equipment, and such a connecting manner does not need other tools for connection, such that the connection is more reliable and convenient; and the base 13 is of a orthohexagonal boss structure, the design is convenient for installation of the base 13, and a lock wire hole 14 is arranged on two adjacent surfaces of a regular hexagon.

An upper cover 10 is arranged on the other end, far away from the base 13, of the housing 12, and the upper cover 10 and the housing are made of nylon, thereby ensuring strength of the housing 12, and simultaneously ensuring smooth transmission of wireless signals to a mobile terminal. The connecting parts among the upper cover 10, the housing 12 and the base 13 are connected by means of an adhesive manner through sealant, to form integrated seal of a wireless communication point inspection vibrometer, and prevent solid particles, dust or liquid from entering into the inside of a wireless communication point inspection vibrometer, since the entrance of solid particles, dust or liquid may influence monitoring precision of a wireless communication point inspection vibrometer; a button 11 is arranged in the middle of the upper cover 10, and the button 11 is connected with the first printed circuit board 7 through a connecting line, to control starting and closing of a wireless communication point inspection vibrometer.

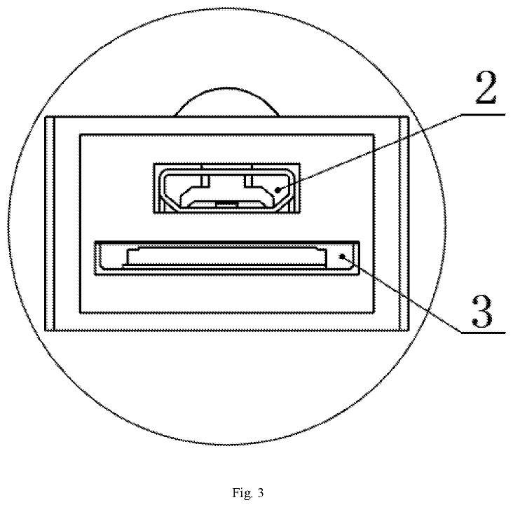

As shown in FIG. 3, a first bracket 1 configured to install the first printed circuit board 7 is arranged in the housing 12, and the first bracket 1 is arranged above the piezoelectric transducer 4. The first bracket 1 is installed with a battery 6 configured to provide power. The battery 6 and the first printed circuit board 7 are both installed on the first bracket 1, the battery 6 is arranged above the first printed circuit board 7, a charging port 2 is arranged on an outer wall of the housing 12, the charging port 2 is connected with the battery 6, a memory card slot 3 is arranged below the charging port 2, the memory card slot 3 is connected with the first printed circuit board 7, information on the first printed circuit board 7 is exported through a memory card, a silicone sealing cover is arranged at the charging port 2 and the memory card slot 3, thereby preventing entrance of dust or liquid which may influence normal operation of a wireless communication point inspection vibrometer, thereby ensuring airtightness of a wireless communication point inspection vibrometer.

As shown in FIG. 1, a light guide post 5 arranged perpendicular to the first printed circuit board 7 is further included, the other end of the light guide post 5 extends to the outside of the housing 12, so as to transmit light source information displayed on the first printed circuit board 7 to the outside of the housing 12. The first printed circuit board 7 is pasted with a patch light source configured to monitor whether a wireless communication point inspection vibrometer is in an operating state, the light guide post 5 is perpendicular to the first printed circuit board 7, the other end extends to the outside of the housing 12 and extends to an upper surface of an upper cover 10, so as to display light of a patch light source on the upper cover 10 through the light guide post 5. A display light is arranged on an upper cover 10, and an operating state of a wireless communication point inspection vibrometer can be directly observed outside through displayed colors of a display light.

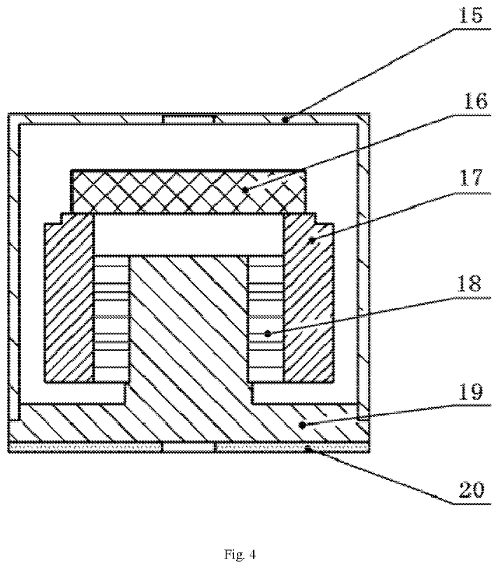

As shown in FIG. 4, the piezoelectric transducer 4 is installed on the base 13 through a second bracket 19, and includes a piezoelectric ceramic 18 and a mass block 17 which are sleeved on the second bracket 19 in sequence from inside to outside, and a second printed circuit board 16 arranged above the mass block 17, and a shielding case 15 is further arranged outside the second bracket 19. The piezoelectric ceramic 18 is an annular structure formed through splicing of multiple single bodies. The piezoelectric ceramic 18 is set to be an annular structure spliced from multiple single bodies, the structure of the piezoelectric ceramic 18 is simple, thereby facilitating processing of the piezoelectric ceramic 18, increasing dramatically sensitivity of a piezoelectric transducer 4, saving space, and reducing volume of a piezoelectric transducer 4. A second printed circuit board 16 functions to amplify charges in a piezoelectric transducer 4, thereby dramatically increasing electrical conductivity and sensitivity of a piezoelectric transducer; a mass block 17 adopts 316L stainless steel, thereby ensuring installation rigidity and contact property of a mass block 17, and increasing electric signals of a piezoelectric ceramic 18; a shielding case 15 wraps a second bracket 19, a piezoelectric ceramic 18, a mass block 17 and a second printed circuit board 16, aiming at isolating a piezoelectric transducer 4 from other components in a wireless communication point inspection vibrometer, achieving a purpose of insulation, and ensuring a favorable signal-to-noise ratio during measurement.

Obviously, the above embodiments are merely examples for clear description, rather than a limitation to the implementation. For those skilled in the art, modifications or variations in different forms can be made based on the above description. Herein, there's no need to describe all the examples, and it's also impossible, while the apparent modifications or variations derived herein all fall into the protection scope of the present disclosure.

1. A wireless communication point inspection vibrometer configured to monitor vibration and temperature of rotating equipment, comprising:
a housing (12), internally provided with a piezoelectric transducer (4), a temperature detection component (8) and a first printed circuit board (7), wherein the piezoelectric transducer (4) and the temperature detection component (8) are both in communication connection with the first printed circuit board (7), and the first printed circuit board (7) is provided with a wireless transmitting component.

2. The wireless communication point inspection vibrometer configured to monitor vibration and temperature of rotating equipment of claim 1, wherein the wireless transmitting component is a wireless patch.

3. The wireless communication point inspection vibrometer configured to monitor vibration and temperature of rotating equipment of claim 1, wherein the housing (12) is internally filled with pouring sealant.

4. The wireless communication point inspection vibrometer configured to monitor vibration and temperature of rotating equipment of claim 1, wherein the housing (12) is provided with a base (13), the piezoelectric transducer (4) is arranged at the center of the base (13), and the temperature detection component (8) is installed in a blind hole formed at a side part of the base (13).

5. The wireless communication point inspection vibrometer configured to monitor vibration and temperature of rotating equipment of claim 4, wherein the base (13) is further internally provided with a mounting hole (9) configured to be connected with the rotating equipment.

6. The wireless communication point inspection vibrometer configured to monitor vibration and temperature of rotating equipment of claim 1, wherein the housing (12) is internally provided with a first bracket (1) configured to install the first printed circuit board (7), and the first bracket (1) is arranged above the piezoelectric transducer (4).

7. The wireless communication point inspection vibrometer configured to monitor vibration and temperature of rotating equipment of claim 6, wherein the first bracket (1) is installed with a battery (6) configured to provide power.

8. The wireless communication point inspection vibrometer configured to monitor vibration and temperature of rotating equipment of claim 1, further comprising a light guide post (5) arranged perpendicular to the first printed circuit board (7), the other end of the light guide post (5) extends to the outside of the housing (12), so as to transmit light source information displayed on the first printed circuit board (7) to the outside of the housing (12).

9. The wireless communication point inspection vibrometer configured to monitor vibration and temperature of rotating equipment of claim 4, wherein the piezoelectric transducer (4) is installed on the base (13) through a second bracket (19), and comprises a piezoelectric ceramic (18) and a mass block (17) which are sleeved on the second bracket (19) in sequence from inside to outside, and a second printed circuit board (16) arranged above the mass block (17), and a shielding case (15) is further arranged outside the second bracket (19).

10. The wireless communication point inspection vibrometer configured to monitor vibration and temperature of rotating equipment of claim 9, wherein the piezoelectric ceramic (18) is an annular structure formed through splicing of multiple single bodies.

11. The wireless communication point inspection vibrometer configured to monitor vibration and temperature of rotating equipment of claim 2, wherein the housing (12) is internally filled with pouring sealant.

12. The wireless communication point inspection vibrometer configured to monitor vibration and temperature of rotating equipment of claim 2, wherein the housing (12) is provided with a base (13), the piezoelectric transducer (4) is arranged at the center of the base (13), and the temperature detection component (8) is installed in a blind hole formed at a side part of the base (13).

13. The wireless communication point inspection vibrometer configured to monitor vibration and temperature of rotating equipment of claim 2, wherein the housing (12) is internally provided with a first bracket (1) configured to install the first printed circuit board (7), and the first bracket (1) is arranged above the piezoelectric transducer (4).

14. The wireless communication point inspection vibrometer configured to monitor vibration and temperature of rotating equipment of claim 2, further comprising a light guide post (5) arranged perpendicular to the first printed circuit board (7), the other end of the light guide post (5) extends to the outside of the housing (12), so as to transmit light source information displayed on the first printed circuit board (7) to the outside of the housing (12).
